(19) United States
(12) Patent Application Publication
(10) Pub. No.: US 2026/0196400 A1
(43) Pub. Date: Jul. 9, 2026

(54) COIL COMPONENT

(71) Applicant: SAMSUNG ELECTRO-MECHANICS CO., LTD., Suwon-si (KR)

(72) Inventor: Kaoru Satake, Suwon-si (KR)

(73) Assignee: SAMSUNG ELECTRO-MECHANICS CO., LTD., Suwon-si (KR)

(21) Appl. No.: 19/396,612

(22) Filed: Nov. 21, 2025

(30) Foreign Application Priority Data
Jan. 8, 2025 (KR) 10-2025-0002752

(51) Int. Cl. H01F 27/04; H01F 27/28; H01F 41/00

(52) U.S. Cl. CPC H01F 27/04; H01F 27/2828; H01F 41/00

(57) ABSTRACT

A coil component includes a body having a first to sixth surfaces, a coil disposed in the body, and including a lead-out portion, and an external electrode including a base portion disposed on the third surface or the fourth surface, an insertion portion bent from one end of the base portion and at least a portion of which is inserted into the body, and a pad portion bent from the other end of the base portion and extending to the first surface, wherein each of the third to sixth surfaces includes a first inclined surface and a second inclined surface inclined in different directions with respect to the first direction, and the insertion portion includes one surface facing the first surface and the other surface facing the second surface, and the lead-out portion contacts the one surface of the insertion portion.

### CROSS-REFERENCE TO RELATED APPLICATION(S

This application claims benefit of priority to Korean Patent Application No. 10-2025-0002752 filed on January 8, 2025 in the Korean Intellectual Property Office, the disclosure of which is incorporated herein by reference in its entirety.

### TECHNICAL FIELD

The present disclosure relates to a coil component.

An inductor, a coil component, is a representative passive electronic component used in electronic devices, along with resistors and capacitors. The coil component may control a flow of current through a coil, remove noise, and protect an electronic device by preventing rapid changes in current therein.

As electronic devices are increasingly implemented with high-performance and are miniaturized, the number of inductors used in electronic devices is also increasing and are miniaturized.

Meanwhile, as the number of electronic devices used in a vehicle increases, especially the number of electronic devices directly mounted in an engine bay increases, there is a demand for an inductor having improved vibration resistance and an improved heat dissipation effect.

### SUMMARY

An aspect of the present disclosure is to provide a coil component having a structure resistant to vibrations and external impacts.

Another aspect of the present disclosure is to provide a coil component having improved heat dissipation by increasing a surface area of a body.

According to an aspect of the present disclosure, a coil component may be provided, the coil component including: a body including a first surface and a second surface, facing each other in a first direction, and third to sixth surfaces connecting the first surface and the second surface, a coil disposed in the body, the coil including a lead-out portion, and an external electrode including a base portion disposed on the third surface or the fourth surface, an insertion portion bent from a first end of the base portion, at least a portion of the insertion portion is inserted into the body, and a pad portion bent from a second end of the base portion and extending to the first surface, wherein each of the third to sixth surfaces includes a first inclined surface and a second inclined surface, the first inclined surface and the second inclined surface are inclined in different directions with respect to the first direction, the insertion portion includes a first surface facing the first surface of the body, and a second surface facing the second surface of the body, and the lead-out portion contacts the first surface of the insertion portion.

### BRIEF DESCRIPTION OF DRAWINGS

The above and other aspects, features, and advantages of the present disclosure will be more clearly understood from the following detailed description, taken in conjunction with the accompanying drawings, in which:

FIG. 1 is a perspective view schematically illustrating a coil component according to a first embodiment of the present disclosure;

FIG. 2 is a cutaway perspective view illustrating the internal configuration of the first embodiment of the coil component illustrated in FIG. 1;

FIG. 3 is a diagram illustrating a cross-section taken along line I-I' of FIG. 1;

FIG. 4 is a diagram illustrating a cross-section taken along line II-II' of FIG. 1;

FIG. 5 is an enlarged view of region B of FIG. 4;

FIG. 6 is an enlarged view of region C of FIG. 5;

FIG. 7 is an enlarged view of region D of FIG. 5;

FIG. 8 is a diagram illustrating a state in which a coil and an external electrode before bending are coupled;

FIG. 9 is a diagram illustrating a process of forming a body with a mold;

FIG. 10 is a schematic perspective view illustrating a coil component according to a second embodiment of the present disclosure; and

FIG. 11 is a diagram illustrating a cross-section taken along line III-III’ of FIG. 10.

### DETAILED DESCRIPTION

The terms used in the present application are only used to describe specific embodiments, and are not intended to limit the present disclosure. The singular expression includes the plural expression unless the context clearly dictates otherwise. In the present application, terms such as “comprise” or “have” are intended to designate that a feature, number, operation, operation, component, part, or combination thereof described in the specification exists, and it should be understood that this does not preclude the possibility of addition or existence of one or more other features or numbers, operations, operations, components, parts, or combinations thereof. Throughout the specification, “on” means to be positioned above or below the target part, and does not necessarily mean to be positioned on the upper side with respect to the direction of gravity.

In addition, the term “coupling” does not mean only a case of direct physical contact between respective components in the contact relationship between respective components, and is used as a concept that encompasses even the case in which other components are interposed between respective components and the components are respectively in contact with the other components.

The size and thickness of each component illustrated in the drawings are arbitrarily indicated for convenience of description, and thus, the present disclosure is not necessarily limited to the illustration.

In the drawings, an L-direction may be defined as a first direction or a length direction, a W-direction may be defined as a second direction or a width direction, and a T-direction may be defined as a third direction or a thickness direction.

Hereinafter, a coil component according to an embodiment will be described in detail with reference to the accompanying drawings, and in describing the coil component with reference to the accompanying drawings, the same or corresponding components are given the same reference numerals, and the overlapping description thereof will be omitted.

Various types of electronic components are used in electronic devices, and among these electronic components, various types of coil components may be appropriately used for noise removal, or the like.

For example, in electronic devices, the coil component may be used as a power inductor, a high frequency (HF) inductor, a general bead, a high frequency bead (GHz Bead), a common mode filter, or the like.

### First Embodiment

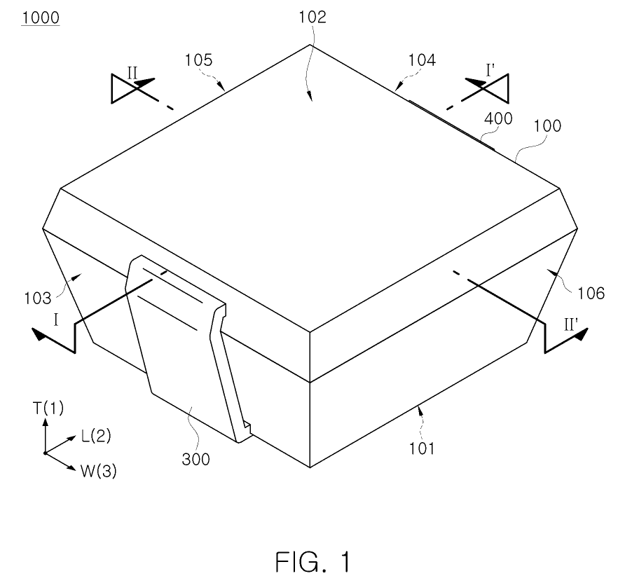

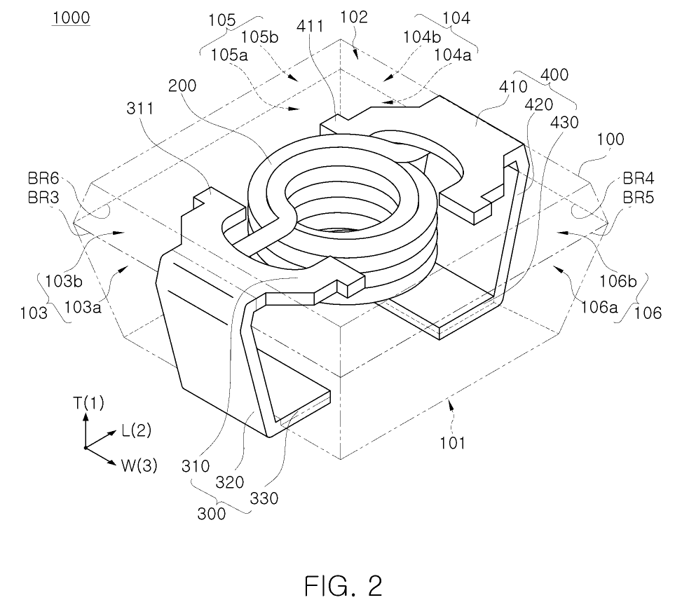

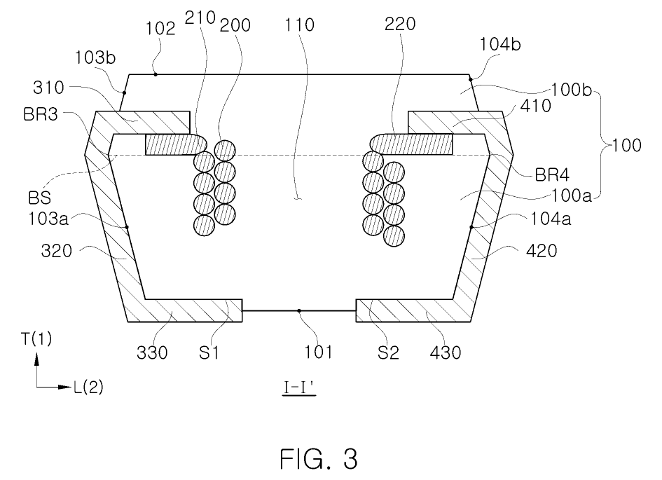

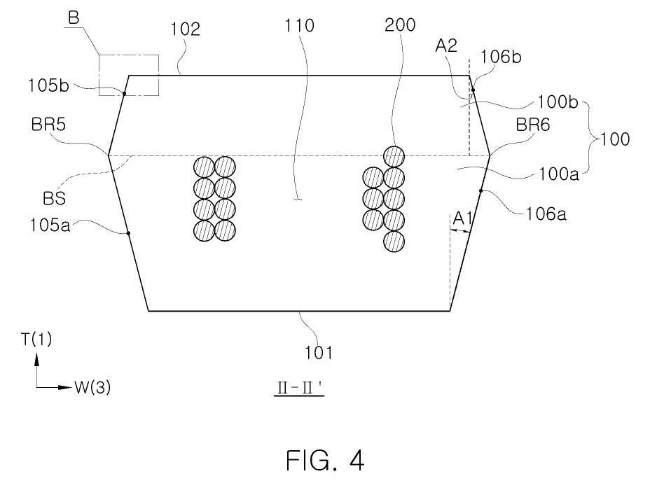

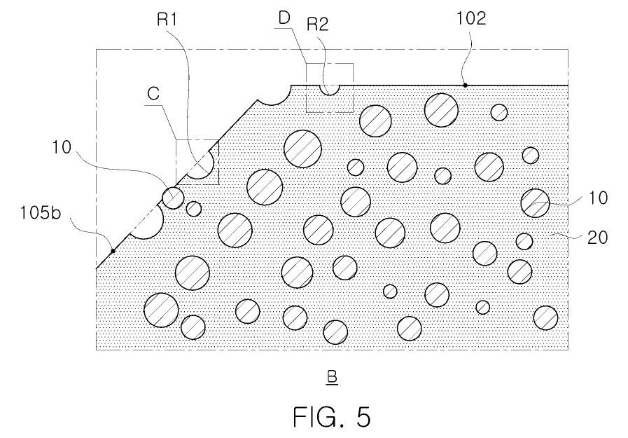

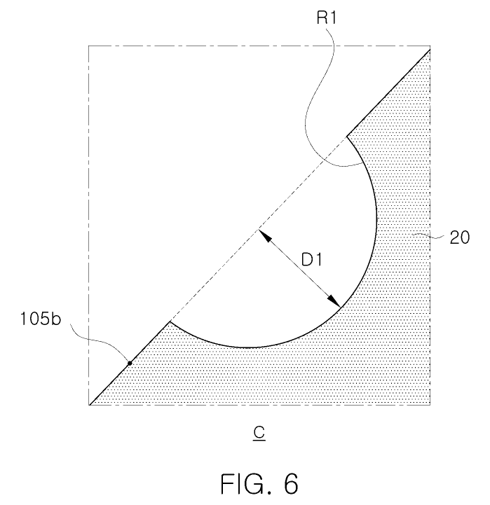

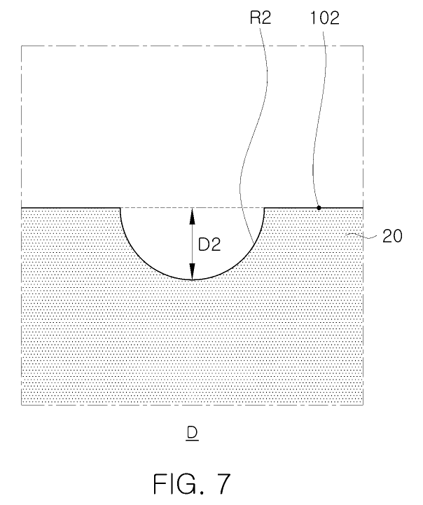

FIG. 1 is a perspective view schematically illustrating a coil component according to a first embodiment of the present disclosure. FIG. 2 is a cutaway perspective view illustrating the internal configuration of the first embodiment of the coil component illustrated in FIG. 1. FIG. 3 is a diagram illustrating a cross-section taken along line I-I' of FIG. 1. FIG. 4 is a diagram illustrating a cross-section taken along line II-II' of FIG. 1. FIG. 5 is an enlarged view of region B of FIG. 4. FIG. 6 is an enlarged view of region C of FIG. 5. FIG. 7 is an enlarged view of region D of FIG. 5.

Referring to FIGS. 1 to 4, a coil component 1000 according to a first embodiment of the present disclosure may include a body 100, a coil 200, and external electrodes 300 and 400. In addition, the external electrodes 300 and 400 may include insertion portions 310 and 410, base portions 320 and 420, and pad portions 330 and 430. In addition, the external electrodes 300 and 400 may include insertion portions 310 and 410, base portions 320 and 420, and pad portions 330 and 430. In addition, based on the direction of FIG. 1, since each side surface connecting upper and lower surfaces of the body 100 includes a first inclined surface and a second inclined surface, inclined in different directions, the body 100 may have a decahedral shape.

According to the present embodiment, the coil component 1000 may have a boundary portion protruding outwardly may be formed in a region in which the first inclined surface and the second inclined surface of each side surface of the body 100 are in contact with each other, and as the base portions 320 and 420 of the external electrodes 300 and 400 are disposed in a form surrounding the boundary portion along the first inclined surface and the second inclined surface, stress may be distributed when the coil component 1000 is mounted on a substrate, thereby enhancing vibration resistance and impact resistance.

In addition, referring to FIGS. 5 to 7, as the coil component 1000 according to the present embodiment has a decahedral shape of the body 100 and a deep recessed portion R1 is formed in the first inclined surface and the second inclined surface, the total surface area of the body 100 may increase, so that heat dissipation performance may be improved.

Hereinafter, the main components constituting the coil component 1000 according to the present embodiment will be described in detail.

The body 100 forms the exterior of the coil component 1000 according to the present embodiment, and the coil 200 is buried therein.

The body 100 may include a first surface 101 and a second surface 102, facing each other in a first direction (T-direction), a third surface 103 and a fourth surface 104, facing each other in a second direction (L-direction), and a fifth surface 105 and a sixth surface 106, facing each other in a third direction (W-direction). Each of the third surface 103, the fourth surface 104, and the sixth surface 106 may include a first inclined surface and a second inclined surface, inclined in different directions, with respect to the first direction (T-direction).

Each of the third surface 103, the fourth surface 104, the fifth surface 105, and the sixth surface 106 of the body 100 may correspond to a side surface of the body 100 connecting the first surface 101 and the second surface 102. Therefore, since each side surface of the body 100 includes the first inclined surface and the second inclined surface, the body 100 of the present embodiment may have an overall decahedral shape.

Based on the maximum sizes in the first direction (T-direction), the second direction (L-direction), and the third direction (W-direction), in the body 100, as an example, the coil component 1000 including the external electrodes 300 and 400 according to the present embodiment may be formed to have a length of 10.0 mm, a width of 10.0 mm, and a thickness of 5.0 mm, to have a length of 6.47 mm, a width of 6.47 mm, and a thickness of 2.8 mm, to have a length of 5.2 mm, a width of 5.2 mm, and a thickness of 2.8 mm, to have a length of 4.0 mm, a width of 4.0 mm, and a thickness of 2.0 mm, to have a length of 4.0 mm, a width of 4.0 mm, and a thickness of 1.5 mm, or to have a length of 4.0 mm, a width of 4.0 mm, and a thickness of 1.2 mm, but the present disclosure is not limited thereto. Meanwhile, the above-described exemplary values for the length, width, and thickness of the coil component 1000 refer to values that do not reflect process errors, and the values within the range that may be recognized as process errors should be considered to correspond to the above-described exemplary values.

Based on an optical microscope image or a scanning electron microscope (SEM) image of a cross-section in a length direction (L)-thickness direction (T), taken from a central portion of the coil component 1000 in a third direction (W-direction), the length of the coil component 1000 described above may refer to a maximum value of dimensions of each of a plurality of line segments, which are provided by connecting two virtual straight lines, respectively passing through an outermost boundary line of the coil component 1000, i.e., outermost points of the external electrodes 300 and 400 and the base portions 320 and 340 and parallel to the first direction (T-direction), based on the second direction (L-direction), to be parallel to the second direction (L-direction) and being spaced apart from each other in the first direction (T-direction). Alternatively, the length of the coil component 1000 may refer to a minimum value of the dimensions of each of the plurality of line segments described above. Alternatively, the length of the coil component 1000 may refer to an arithmetic mean value of at least three or more of the dimensions of each of the plurality of line segments described above. In this case, the plurality of line segments, parallel to the second direction (L-direction) may be equally spaced from each other in the first direction (T-direction), but the scope of the present disclosure is not limited thereto.

Based on an optical microscope image or a scanning electron microscope (SEM) image of a cross-section in a width direction (W)-thickness direction (T), taken from a central portion of the coil component 1000 in a second direction (L-direction), the width of the coil component 1000 described above may refer to a maximum value of dimensions of each of a plurality of line segments, which are provided by connecting two virtual straight lines, respectively passing through an outermost boundary line of the coil component 1000, i.e., boundary portions BR5 and BR6, which are outermost points of the body 100 and parallel to the third direction (W-direction), based on the third direction (W-direction), to be parallel to the third direction (W-direction) and being spaced apart from each other in the first direction (T-direction). Alternatively, the width of the coil component 1000 may refer to a minimum value of the dimensions of each of the plurality of line segments described above. Alternatively, the width of the coil component 1000 may refer to an arithmetic mean value of at least three or more of the dimensions of each of the plurality of line segments described above. In this case, the plurality of line segments, parallel to the third direction (W-direction) may be equally spaced from each other in the first direction (T-direction), but the scope of the present disclosure is not limited thereto.

Based on an optical microscope image or a scanning electron microscope (SEM) image of a cross-section in a length direction (L)-thickness direction (T), taken from a central portion of the coil component 1000 in a third direction (W-direction), the thickness of the coil component 1000 described above may refer to a maximum value of dimensions of each of a plurality of line segments, which are provided by connecting two outermost boundary lines of the coil component 1000, facing each other in the first direction (T-direction), illustrated in the cross-sectional image, to be parallel to the first direction (T-direction), and being spaced apart from each other in the second direction (L-direction). Alternatively, the thickness of the coil component 1000 may refer to a minimum value of the dimensions of each of the plurality of line segments described above. Alternatively, the thickness of the coil component 1000 may refer to an arithmetic mean value of at least three or more of the dimensions of each of the plurality of line segments described above. In this case, the plurality of line segments, parallel to the first direction (T-direction) may be equally spaced from each other in the second direction (L-direction), but the scope of the present disclosure is not limited thereto.

Alternatively, each of the length, width, and thickness of the coil component 1000 may be measured by a micrometer measurement method. The micrometer measurement method may be performed by setting the zero point with a gage Repeatability and Reproducibility (R&R) micrometer, inserting the coil component 1000 according to this embodiment between the tips of the micrometer and turning the measuring lever of the micrometer. On the other hand, in measuring the length of the coil component 1000 by the micrometer measurement method, the length of the coil component 1000 may refer to a value measured once, and may also refer to an arithmetic mean of values measured multiple times. This may equally be applied to the width and thickness of the coil component 1000.

Referring to FIGS. 1 to 4, the body 100 of the present embodiment may have a decahedral shape. The body 100 has a first surface 101 and a second surface 102 facing each other in a first direction (T-direction), and a third surface 103, a fourth surface 104, a fifth surface 105, and a sixth surface 106, four side surfaces connecting the first surface 101 and the second surface 102, wherein each of the four side surfaces may include first inclined surfaces 103a, 104a, 105a, and 106a and second inclined surfaces 103b, 104b, 105b, and 106b, inclined in different directions with respect to the first direction (T-direction).

In addition, an inclination A1 of a first inclined surface and an inclination A2 of a second inclined surface may be different from each other, and for example, may be formed at an angle greater than 0 degrees and less than 3 degrees with respect to the first direction (T-direction), but the present disclosure is not limited thereto. The inclination A1 and A2 and the direction of inclination may be determined using an optical microscope or a scanning electron microscope. Other methods and/or tools appreciated by one of ordinary skill in the art, even if not described in the present disclosure, may also be used.

First inclined surfaces 103a, 104a, 105a, and 106a may be connected to the first surface 101 of the body 100, and second inclined surfaces 103b, 104b, 105b, and 106b may be connected to the second surface 102 of the body 100. In addition, a boundary portion BR may be formed in a region in which the first inclined surfaces 103a, 104a, 105a, and 106a and the second inclined surfaces 103b, 104b, 105b, and 106b are in contact with each other on each side surface, and the boundary portion BR may have a shape protruding outwardly. Referring to FIG. 3, a boundary portion BR3 protruding outwardly may be formed in a region in which the first inclined surface 103a and the second inclined surface 103b of the third surface 103 are in contact with each other, and a boundary portion BR4 protruding outwardly may be formed in a region in which the first inclined surface 104a and the second inclined surface 104b of the fourth surface 104 are in contact with each other. In addition, referring to FIG. 4, a boundary portion BR5 protruding outwardly may be formed in a region in which the first inclined surface 105a and the second inclined surface 105b of the fifth surface 105 are in contact with each other, and a boundary portion BR6 protruding outwardly may be formed in a region in which the first inclined surface 106a and the second inclined surface 106b of the sixth surface 106 are in contact with each other.

Referring to FIG. 3, in a cross-section perpendicular to the third direction (W-direction), the length of the body 100 in the second direction (L-direction) may be maximum in a region passing through the boundary portions BR3 and BR4. In addition, referring to FIG. 4, in a cross-section perpendicular to the second direction (L-direction), the width of the body 100 in the third direction (W-direction) may be maximum in a region passing through the boundary portions BR5 and BR6. The maximum length and maximum width of the body 100 may be determined using an optical microscope or a scanning electron microscope. Other methods and/or tools appreciated by one of ordinary skill in the art, even if not described in the present disclosure, may also be used.

In addition, referring to FIGS. 2 to 4, the body 100 of the present embodiment may include a first region 100a between a boundary surface BS and the first surface 101 and a second region 100b between the boundary surface BS and the second surface 102, based on a virtual boundary surface BS including boundary portions BR3, BR4, BR5, and BR6 of each of the third surface 103, the fourth surface 104, the fifth surface 105, and the sixth surface 106. In addition, based on the cross-section perpendicular to the first direction (T-direction), a cross-sectional area of the body 100 may be maximum at the boundary surface BS. Specifically, the cross-sectional area of the body 100 may gradually increase as it approaches the boundary surface BS from the first surface 101, and may gradually decrease as it approaches the second surface 102 from the boundary surface BS. The maximum cross-sectional area of the body 100 may be determined using an optical microscope or a scanning electron microscope. Other methods and/or tools appreciated by one of ordinary skill in the art, even if not described in the present disclosure, may also be used.

Referring to FIGS. 4 to 7, recessed portions R1 and R2 may be formed on the surface of the body 100 of the present embodiment. Specifically, at least a portion of the third surface 103, the fourth surface 104, the fifth surface 105, and the sixth surface 106 of the body 100 may include at least one first recessed portion R1. In addition, at least a portion of the first surface 101 and the second surface 102 of the body 100 may include at least one second recessed portion R2. Referring to FIGS. 6 and 7, a maximum depth D1 of the first recessed portion R1 may be formed deeper than a maximum depth D2 of the second recessed portion R2.

For example, at least one of the first recessed portion R1 may have a hemispherical shape, with a maximum depth D1 of 0.5 μm or more, but the present disclosure is not limited thereto. Here, the term “hemispherical shape” is not limited to a cross-sectional shape that is exactly a semicircle, but also includes a shape that is nearly hemispherical. For example, based on an optical microscope image or a Scanning Electron Microscope (SEM) image for a W-T cross-section taken from a central portion of the coil component 1000 in the second direction (L-direction), the maximum depth D1 of the first recessed portion R1 may be defined as a distance from an extension line of the surface of the body 100 to an innermost point of the first recessed portion R1, for each of the first recessed portions R1 observed on the first inclined surfaces 105a and 106a and the second inclined surfaces 105b and 106b. In addition, the depth D2 of the second recessed portion R2 may also be measured in a similar manner. The maximum depths D1 and D2 may be determined using an optical microscope or a scanning electron microscope. Other methods and/or tools appreciated by one of ordinary skill in the art, even if not described in the present disclosure, may also be used.

In the present embodiment, a difference in depths between the first recessed portion R1 and the second recessed portion R2 may be implemented by adjusting hardness of an abrasive during surface polishing. For example, the first surface 101 and the second surface 102 of the body 100 may be surface-polished using a high-hardness abrasive, so that the depth D2 of the second recessed portion R2 may be formed to be shallow. In this case, it is easy to distinguish between a direction recognition mark that can be disposed on the first surface 101 or the second surface 102 of the body 100 and the second recessed portion R2, thereby preventing a decrease in visibility during image recognition.

Referring to FIGS. 5 to 7, inner surfaces of the first recessed portion R1 and the second recessed portion R2 may include a resin 20. Meanwhile, non-delaminated magnetic metal particles 10 may be exposed on at least a portion of the third surface 103, the fourth surface 104, the fifth surface 105, and the sixth surface 106 of the body 100.

Since the body 100 of the coil component 1000 according to the present embodiment includes a first inclined surface and a second inclined surface on each side surface, the body 100 has an overall decahedral shape, so that a surface area thereof may be increased. In addition, when the body 100 is separated from a mold after the body 100 is formed, friction with the mold and resulting deformation of the surface of the body 100 may be minimized compared to when there is no inclination on a side surface of the body 100. As a result thereof, the side surface of the body 100 of the present embodiment hardly shows any form of the magnetic metal particles 10 being pushed by friction, and may include a first recessed portion R1 formed by the magnetic metal particles 10 being removed with minimal deformation.

Each side surface of the body 100 of the present embodiment may include a first inclined surface and a second inclined surface, and a first recessed portion R1 may be formed on surfaces of the first inclined surface and the second inclined surface, so that the entire surface area of the body 100 may be increased, and heat dissipation performance through the body 100 may be improved. In addition, since irregular surfaces such as traces of magnetic metal particles 10 or a resin 20 being pushed on each side surface of the body 100 may be minimized, uniform heat dissipation performance may be exhibited on each side surface of the body 100.

Referring to FIGS. 3 and 4, the body 100 may include a core 110. The core 110 may refer to a region of the body 100, filled to penetrate through an air core of the coil 200. The core 110 may be disposed within an inner region of the coil 200 forming at least one turn, and a cross-section of the core 110 may be circular or elliptical in a cross-section perpendicular to a winding axis of the coil 200, but the present disclosure is not limited thereto, and when the coil 200 has a square shape, the cross-section of the core 110 may also have a square shape.

Referring to FIG. 3, step portions S1 and S2 may be formed on the first surface 101 of the body 100. The step portions S1 and S2 are spaces accommodating a portion of the pad portions 330 and 430 of the external electrodes 300 and 400 and is formed along the shape of the pad portions 330 and 430, and may include a first step portion S1 and a second step portion S2, spaced apart from each other in the second direction (L-direction). However, an embodiment of the present disclosure is not limited thereto, and in an embodiment, the pad portions 330 and 430 may also be disposed in a protruding form on a flat surface of the body 100 without the step portions S1 and S2.

The coil component 1000 of the present embodiment may be made thinner by the step portions S1 and S2, and when horizontal vibration occurs during substrate mounting of the coil component 1000, vibration resistance may be improved by interference between the step portions S1 and S2 and the pad portions 330 and 430.

The body 100 may include a magnetic material and a resin 20. The body 100 may be formed by filling a mold with a magnetic material, or may be formed by filling a mold with a composite material including a magnetic material and a resin 20. A molding process of applying high temperature and high pressure to the magnetic material or composite material within the mold may be additionally performed, but the present disclosure is not limited thereto.

The body 100 may be formed to have two regions, upper and lower regions, centered on a coil 200, for example, and may be combined with each other to form one body 100. In this case, the upper and lower regions of the body 100 may have different densities depending on a formation temperature or pressure thereof, and the components included in each of the upper and lower regions thereof may also be partially different, but an embodiment thereof is not limited thereto.

The magnetic material included in the body 100 may be, for example, ferrite or magnetic metal particles 10.

Ferrite may be at least one of, for example, spinel-type ferrites such as Mg-Zn, Mn-Zn, Mn-Mg, Cu-Zn, Mg-Mn-Sr, Ni-Zn, and the like, hexagonal ferrites such as Ba-Zn, Ba-Mg, Ba-Ni, Ba-Co, and Ba-Ni-Co, and the like, garnet-type ferrites such as Y and the like, and Li ferrites.

The magnetic metal particles 10 may include at least one selected from the group consisting of iron (Fe), silicon (Si), chromium (Cr), cobalt (Co), molybdenum (Mo), aluminum (Al), niobium (Nb), copper (Cu), boron (B), zirconium (Zr), hafnium (Hf), phosphorus (P), and nickel (Ni). For example, the magnetic metal particles 10 may be at least one of pure iron powder, Fe-Si alloy powder, Fe-Si-Al alloy powder, Fe-Ni alloy powder, Fe-Ni-Mo alloy powder, Fe-Ni-Mo-Cu alloy powder, Fe-Co alloy powder, Fe-Ni-Co alloy powder, Fe-Cr alloy powder, Fe-Cr-Si alloy powder, Fe-Si-Cu-Nb alloy powder, Fe-Ni-Cr alloy powder, and Fe-Cr-Al alloy powder.

The magnetic metal particles 10 may be amorphous and/or crystalline particles. For example, the magnetic metal particles 10 may be a Fe-Si-B-Cr-based amorphous alloy particles, but the present disclosure is not limited thereto.

Each of ferrite and magnetic metal particles 10 may have an average diameter of about 1 μm to 40 μm, but the present disclosure is not limited thereto.

The body 100 may include two or more types of magnetic materials dispersed in a resin. In this case, the different types of magnetic materials mean that the magnetic materials dispersed in the resin are distinguished from each other by any one of an average diameter, composition, crystallinity, and shape.

The resin 20 may coat the magnetic metal particles 10 and be positioned between the magnetic metal particles 10 to bond the magnetic metal particles 10, and prevent a flow of eddy current between the magnetic metal particles 10 through insulation, thereby reducing eddy current loss. The resin 20 may bond between the magnetic metal particles 10 by being hardened through heat treatment after pressure molding in a process for forming the body 100.

The resin 20 may include epoxy, polyimide, liquid crystal polymer, or the like, alone or in combination thereof, but the present disclosure is not limited thereto. For example, the resin 20 may be an insulating thermosetting resin corresponding to an epoxy-based, phenol-based, polyimide-based, acrylic-based, vinyl ether-based resin, or a mixture thereof.

The coil 200 is disposed in the body 100, and is configured to express the characteristics of the coil component 1000. For example, when the coil component 1000 of the present embodiment is utilized as a power inductor, the coil 200 may function to stabilize power of an electronic device by storing an electric field as a magnetic field and maintaining an output voltage.

Referring to FIGS. 2 to 4, the coil 200 forms at least one turn centered on the core 110, and may include lead-out portions 210 and 220 at both ends thereof. Specifically, the coil 200 may include a first lead-out portion 210, drawn out to the first surface 101 of the body 100, and a second lead-out portion 220, drawn out to the second surface 102 of the body 100.

The coil component 1000 according to the first embodiment of the present disclosure may be disposed so that, based on the direction of FIG. 3, the lead-out portions 210 and 220 are in contact with lower surfaces of insertion portions 310 and 410 of the external electrodes 300 and 400. Specifically, the insertion portions 310 and 410 may include one surface (e.g., a first surface) facing the first surface 101 of the body 100, and the other surface (e.g., a second surface) facing the second surface 102 of the body 100, the first lead-out portion 210 may be in contact with one surface of the insertion portion 310 of the first external electrode 300, and the second lead-out portion 220 may be in contact with one surface of the insertion portion 410 of the second external electrode 400.

Referring to FIG. 3, in the present embodiment, the lead-out portions 210 and 220 may be disposed in a second region 100b of the body 100. That is, based on the direction of FIG. 3, the lead-out portions 210 and 220 may be disposed above a boundary surface BS between the first region 100a and the second region 100b of the body 100.

The coil 200 of the present embodiment may correspond to an air-core coil and may be a wound coil, but an embodiment of the present disclosure is not limited thereto. The coil 200 may be coated with an insulating material in the remaining region, except for the lead-out portions 210 and 220 connected to the external electrodes 300 and 400. Accordingly, a surface of each turn of the coil 200 may be coated with an insulating material, so that insulation may be maintained even after winding.

For example, the coil 200 may be formed by winding a metal wire of which a surface is coated with an insulating material such as a polyamide-imide (PAI) resin in a spiral shape around an air core. The metal wire may be a copper wire, and may be a circular conductor having a diameter of a cross-section thereof of 0.5 mm, but an embodiment thereof is not limited thereto.

Meanwhile, the coil component 1000 according to the present embodiment exemplifies a case in which the coil 200 is formed as a circular conductor, but an embodiment thereof is not limited thereto, and when the coil 200 is formed using a flat metal wire, a cross-section of each turn of the coil 200 may be a square shape.

The coil 200 of the present embodiment may include a conductive material such as copper (Cu), aluminum (Al), silver (Ag), tin (Sn), gold (Au), nickel (Ni), lead (Pb), titanium (Ti), chromium (Cr), molybdenum (Mo), or an alloy thereof, but an embodiment thereof is not limited thereto.

Referring to FIGS. 2 and 3, a coil component 1000 according to the present embodiment may include external electrodes 300 and 400 disposed on the body 100 and connected to the coil 200.

When the coil component 1000 according to the present embodiment is mounted on a circuit board, or the like, the external electrodes 300 and 400 are configured to electrically connect the coil component 1000 and the circuit board. For example, a pad portion 330 of the first external electrode 300 and a pad portion 440 of the second external electrode 400, disposed to be spaced apart from each other on the first surface 101 of the body 100, may be electrically connected to a connection portion of the circuit board.

Referring to FIGS. 2 and 3, the external electrodes 300 and 400 of the present embodiment may include base portions 320 and 420 disposed on the third surface 103 or the fourth surface 104 of the body 100, insertion portions 310 and 410 bent from one end (e.g., a first end) of the base portions 320 and 420 and at least a portion of which is inserted into the body 100, and pad portions 330 and 430 bent from the other end (e.g., a second end) of the base portions 320 and 420 and extending to the first surface 101 of the body 100. The insertion portions 310 and 410, the base portions 320 and 420, and the pad portion 330 and 430 may be formed integrally, which is only defined by dividing regions of the external electrodes 300 and 400 for convenience of explanation.

Referring to FIGS. 2 and 3, the insertion portions 310 and 410 may have one end disposed in the body 100 and the other end bent to be connected to the base portions 320 and 420. In addition, the insertion portions 310 and 410 may be in contact with the lead-out portions 210 and 220. Specifically, the insertion portions 310 and 410 may include one surface facing the first surface 101 of the body 100 and the other surface facing the second surface 102 of the body 100, and one surface of the insertion portions 310 and 410 may be in contact with the lead-out portions 210 and 220.

The insertion portions 310 and 410 of the present embodiment may be disposed in the second region 100b of the body 100. That is, based on the direction of FIG. 3, the insertion portions 310 and 410 may be disposed above the boundary surface BS between the first region 100a and the second region 100b of the body 100.

The insertion portions 310 and 410 may have the function of fixing the external electrodes 300 and 400 to the body 100, and may be disposed to face the pad portions 330 and 430 in a first direction (T-direction), so that the coil component 100 according to the present embodiment may have improved vibration resistance against vibrations in the third direction (T-direction), when the coil component 1000 is mounted on the substrate.

Referring to FIG. 2, the insertion portions 310 and 410 may have the function of fixing the external electrodes 300 and 400 to the body 100, and may include protrusions 311 and 411 at inner ends thereof. The protrusions 311 and 411 may protrude toward the fifth surface 105 and the sixth surface 106 of the body 100, respectively. However, an embodiment of the present disclosure is not limited thereto, and the protrusions 311 and 411 may be formed on only one of the inner ends of the insertion portions 310 and 410.

The protrusions 311 and 411 may have an anchoring function in the body 100, which can further strengthen bonding force between the external electrodes 300 and 400 and the body 100. The protrusions 311 and 411 may have a shape protruding from the inner ends of the insertion portions 310 and 410 in a third direction (W), but the present disclosure is not limited thereto, and a protruding direction or shape of the protrusions 311 and 411 may be variously formed.

Referring to FIGS. 2 and 3, the base portions 320 and 420 of the external electrodes 300 and 400 may be disposed along the first inclined surfaces 103a and 104a and the second inclined surfaces 103b and 104b, in each of the third surface 103 and the fourth surface 104 of the body 100. Specifically, the first base portion 320 of the first external electrode 300 may be disposed along the first inclined surface 103a and the second inclined surface 103b of the third surface 103 of the body 100, and the second base portion 420 of the second external electrode 400 may be disposed along the first inclined surface 104a and the second inclined surface 104b of the fourth surface 104 of the body 100.

Meanwhile, the base portions 320 and 420 may be bent in a form surrounding boundary portions BR3 and BR4 protruding in the second direction (L-direction).

Through the structure described above, when vibration in horizontal directions (L-direction and W-direction) occurs when the coil component 1000 is mounted on the substrate, stress may be distributed along the base portions 320 and 420, so that impacts transmitted to a connection portion between the insertion portions 310 and 410 and the lead-out portions 210 and 220 may be alleviated.

In addition, when vibration in a vertical direction (T-direction) occurs when the coil component 1000 is mounted on the substrate, the bent region of the first base portion 320 may be engaged with the boundary portion BS3 of the third surface 103, and the bent region of the second base portion 420 may be engaged with the boundary portion BS4 of the fourth surface 104, so that the bonding force between the body 100 and the external electrodes 300 and 400 may be strengthened.

Referring to FIGS. 2 and 3, the external electrodes 300 and 400 may further include pad portions 330 and 430 bent from the base portions 320 and 420 and extending to the first surface 101 of the body 100. The pad portions 330 and 430 are configured to be connected to a connection portion of a substrate, when the coil component 1000 is mounted on the substrate, and for example, a bonding member such as solder, or the like may be disposed, so that the coil component 1000 and the circuit may be electrically connected.

The pad portions 330 and 430 may be bent and extended from the base portions 320 and 420 in the second direction (L-direction) and disposed on step portions S1 and S2 formed on the first surface 101 of the body 100. However, an embodiment thereof is not limited thereto, and when the first surface 101 of the body 100 is a flat surface without step portions S1 and S2, the pad portions 330 and 430 may be disposed directly on the first surface 101 of the body 100.

Meanwhile, the external electrodes 300 and 400 of the present embodiment may include a conductive material such as copper (Cu), aluminum (Al), silver (Ag), tin (Sn), gold (Au), nickel (Ni), lead (Pb), titanium (Ti), chromium (Cr), molybdenum (Mo), or an alloy thereof, and may be formed in a multilayer, but the present disclosure is not limited thereto. In addition, the external electrodes 300 and 400 may be formed as a conductive metal plate such as copper (Cu) or phosphor bronze through a rolling process. For example, the external electrodes 300 and 400 may be formed to have a thickness of 0.2 mm, but the present disclosure is not limited thereto.

In addition, the coil component 1000 according to the present embodiment may further include an insulating layer (not shown) covering the surface of the body 100.

The insulating layer may be formed by a method such as a printing method, vapor deposition, spray coating method, or film lamination method, but the present disclosure is not limited thereto.is not limited thereto.

The insulating layer may include a thermoplastic resin such as polystyrene, vinyl acetate, polyester, polyethylene, polypropylene, polyamide, rubber, or acrylic; a thermosetting resin such as phenol, epoxy, urethane, melamine, or alkyd; a photosensitive resin, parylene, SiOx, or SiNx. The insulating layer may further include an insulating filler, such as an inorganic filler, but the present disclosure is not limited thereto.

### Method of manufacturing a coil component

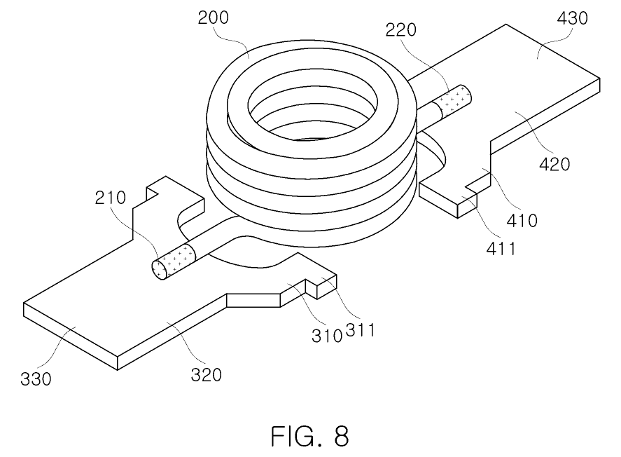

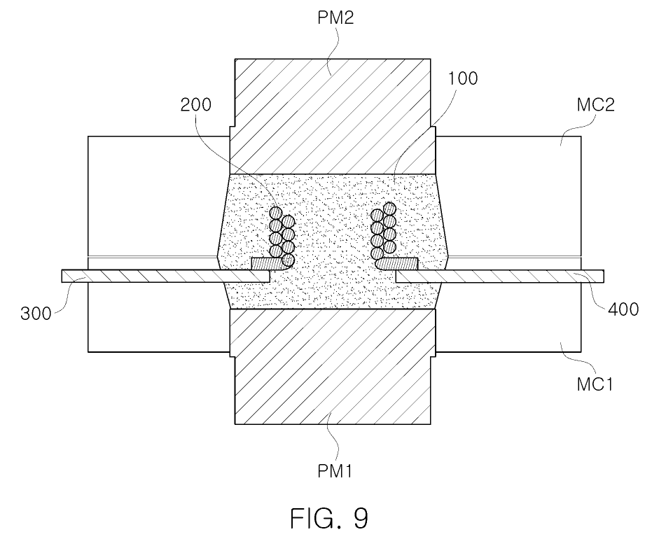

FIG. 8 is a diagram illustrating a state in which a coil 200 and external electrodes 300 and 400 are coupled before bending. FIG. 9 is a diagram illustrating a process for forming a body 100 with a mold (MC1, MC2).

Referring to FIG. 8, a coil 200 may be disposed on external electrodes 300 and 400, which are not bent, and lead-out portions 210 and 220 and the external electrodes 300 and 400 may be bonded to each other. The external electrodes 300 and 400 may correspond to an electrode fixed to a frame. Insulating coating of the lead-out portions 210 and 220 may be removed from a region thereof in contact with the external electrodes 300 and 400. For example, the coupling between the lead-out portions 210 and 220 and the external electrodes 300 and 400 may be performed by resistance welding, but an embodiment thereof is not limited thereto.

Referring to FIG. 9, a lower mold MC1 having a tapered shape may be filled with magnetic metal powder and a resin, and after the coil 200 and the external electrodes 300 and 400 are coupled to each other in FIG. 8 are disposed, and then an upper mold MC2 having a side surface inclined in the opposite direction to the lower mold MC may be combined and the magnetic metal powder and a resin may be filled. Thereafter, a body 100 may be formed by applying pressure in the upper and lower directions through pressing members PM1 and PM2. For example, pressing force of the pressing members PM1 and PM2 may be 5 t/cm², but an embodiment thereof is not limited thereto.

Meanwhile, considering a bending position of the external electrodes 300 and 400, the external electrodes 300 and 400 before bending may be disposed closer to the lower mold MC1 than to the upper mold MC2 within the body 100.

When a body 100 is formed using a tapered mold (MC1, MC2) as in the present embodiment, friction may be minimized in a process of separating the body 100 from the mold (MC1, MC2), and thus deformation such as surface pushing due to friction may be minimized.

### Second Embodiment

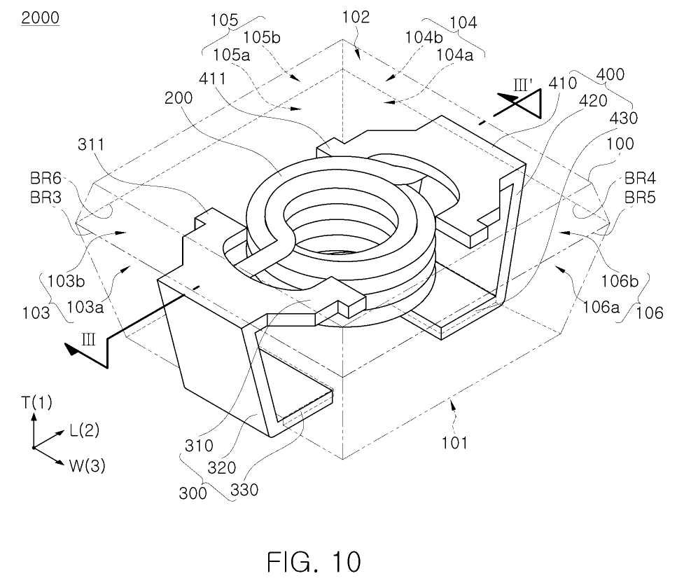

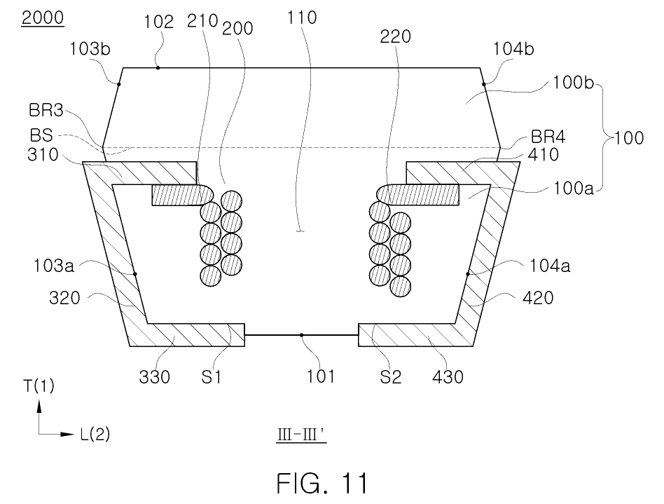

FIG. 10 is a perspective view schematically illustrating a coil component 2000 according to a second embodiment of the present disclosure. FIG. 11 is a cross-sectional view taken along line III-III’ of FIG. 10.

Comparing FIGS. 11 and 12 with FIGS. 2 and 3, respectively, positions of lead-out portions 210 and 220, positions of insertion portions 310 and 410, and shapes and lengths of base portions 320 and 430 are different. Therefore, in describing the present embodiment, only the positions of the lead-out portions 210 and 220, the positions of the insertion portions 310 and 410, and the shape and the length of the base portions 320 and 420 will be described, and the description in the first embodiment of the present disclosure may be applied as it is to the remaining components.

Referring to FIGS. 10 and 11, the coil component 2000 according to the second embodiment of the present disclosure may have a position in which the insertion portions 310 and 410 of the external electrodes 300 and 400 are inserted into the body 100 in a lower position than in the first embodiment. That is, the first insertion portion 310 may be inserted into a first inclined surface 103a of the third surface 103 of the body 100, and the second insertion portion 410 may be inserted into a first inclined surface 104a of the fourth surface 104 of the body 100.

As a result thereof, the insertion portions 310 and 410 of the present embodiment may be disposed in a first region 100a of the body 100. That is, based on the direction of FIG. 11, the insertion portions 310 and 410 may be disposed below a boundary surface BS between the first region 100a and the second region 100b of the body 100.

In addition, the lead-out portions 210 and 220 may be disposed to be in contact with lower surfaces of the insertion portions 310 and 410 of the external electrodes 300 and 400, and accordingly, the lead-out portions 210 and 220 may be disposed in the first region 100a of the body 100. That is, based on the direction of FIG. 11, the lead-out portions 210 and 220 may be disposed below the boundary surface BS between the first region 100a and the second region 100b of the body 100.

According to the present embodiment, the coil component 2000 has the lower center of gravity of the entire coil component 2000 as the insertion portions 310 and 410 are fixed at first inclined surfaces 103a and 104a on a side surface of the body 100, that is, at a low position, so that vibration resistance may be improved when the coil component 2000 is mounted on a substrate. In addition, as the length of the base portion 320 and 420 is shortened, a fixed gap between the insertion portions 310 and 410 and the pad portions 330 and 430 may be reduced, so that the vibration resistance against up-and-down vibration may be improved.

According to an embodiment of the present disclosure, a coil component may have improved vibration resistance and impact resistance, by appropriately distributing stress applied to the coil component through a shape of a body and a disposition of an external electrode.

A coil component according to an embodiment of the present disclosure may have improved heat dissipation properties, by increasing a surface area of the body.

While example embodiments have been illustrated and described above, it will be apparent to those skilled in the art that modified examples and variations could be made without departing from the scope of the present disclosure as defined by the appended claims.

What is claimed is:

1. A coil component, comprising:
a body including a first surface and a second surface, facing each other in a first direction, and third to sixth surfaces connecting the first surface and the second surface;
a coil disposed in the body, the coil including a lead-out portion; and
an external electrode including:
a base portion disposed on the third surface or the fourth surface,
an insertion portion bent from a first end of the base portion, at least a portion of the insertion portion being inserted into the body, and
a pad portion bent from a second end of the base portion and extending to the first surface,
wherein each of the third to sixth surfaces includes a first inclined surface and a second inclined surface, the first inclined surface and the second inclined surface being inclined in different directions with respect to the first direction, and
the insertion portion includes a first surface facing the first surface of the body, and a second surface facing the second surface of the body, and the lead-out portion contacts the first surface of the insertion portion.

2. The coil component of claim 1, wherein the first inclined surface is connected to the first surface of the body, and the second inclined surface is connected to the second surface of the body.

3. The coil component of claim 1, wherein a region in which the first inclined surface and the second inclined surface contact each other includes a boundary portion, and
the boundary portion protrudes outwardly.

4. The coil component of claim 3, wherein the third surface of the body and the fourth surface of the body face each other in a second direction, perpendicular to the first direction, and the fifth surface of the body and the sixth surface of the body face each other in a third direction, perpendicular to each of the first direction and the second direction, and
in a cross-section of the coil component perpendicular to the third direction, a length of the body in the second direction is maximum in a region passing through the boundary portion.

5. The coil component of claim 4, wherein in a cross-section of the coil component perpendicular to the second direction, a width of the body in the third direction is maximum in the region passing through the boundary portion.

6. The coil component of claim 3, wherein, based on a virtual boundary surface including the boundary portion of each of the third to sixth surfaces, the body includes a first region between the virtual boundary surface and the first surface, and a second region between the virtual boundary surface and the second surface, and
based on a cross-section of the coil component perpendicular to the first direction, a cross-sectional area of the body is maximum at the virtual boundary surface.

7. The coil component of claim 6, wherein the insertion portion is disposed in the second region.

8. The coil component of claim 7, wherein the lead-out portion is disposed in the second region.

9. The coil component of claim 6, wherein the insertion portion is disposed in the first region.

10. The coil component of claim 1, wherein, in each of the third surface and the fourth surface, the base portion is disposed along the first inclined surface and the second inclined surface.

11. The coil component of claim 1, wherein the insertion portion includes a protrusion protruding toward each of the fifth surface and the sixth surface.

12. The coil component of claim 1, wherein a step portion is on the first surface, and the pad portion is disposed in the step portion.

13. The coil component of claim 1, wherein at least a portion of the third to sixth surfaces include at least one first recessed portion, and at least a portion of the first surface and the second surface include at least one second recessed portion, and
a maximum depth of the at least one first recessed portion is deeper than a maximum depth of the at least one second recessed portion.

14. The coil component of claim 13, wherein the at least one first recessed portion has a hemispherical shape.

15. The coil component of claim 13, wherein inner surfaces of the first and second recessed portions include a resin.

16. The coil component of claim 13, wherein the body further includes magnetic metal particles, and at least one magnetic metal particle among the magnetic metal particles is exposed on at least a portion of the third to sixth surfaces.

17. A method of forming the coil component of claim 13, comprising polishing the first surface of the body and the second surface of the body.
